(19) United States
(12) Patent Application Publication
(10) Pub. No.: US 2023/0316388 A1
(43) Pub. Date: Oct. 5, 2023

(54) SEARCH NAVIGATION SYSTEM AND METHOD USING DYNAMIC GRAPH BASED ON PRODUCT CATALOGUE AND STOCK LEVELS

(71) Applicant: Donde Fashion, Inc., Wilmington, DE (US)

(72) Inventors: Omer Bar-Sade, Herzliya (IL); Roni Gurvich, Ramat Gan (IL); Gideon Caller, Kfar Saba (IL)

(21) Appl. No.: 17/708,895

(22) Filed: Mar. 30, 2022

(51) Int. Cl. G06Q 30/06; G06Q 10/08

(52) U.S. Cl. CPC G06Q 30/0643; G06Q 10/087

(57) ABSTRACT

The present disclosure provides a search navigation system and method for an online store. The search navigation method includes obtaining attribute tags associated with available inventory associated with the online store, and detecting a buyer event associated with the online store. In response to the buyer event, a search navigation graph is generated for the online store based on a search navigation template graph. The search navigation graph comprises a hierarchical graph where each node in the search navigation graph represents a respective attribute tag, and the search navigation graph includes only nodes of the search navigation template graph representing attribute tags associated with the available inventory associated with the online store. A search navigation bar with selectable icons is displayed in a user interface. The selectable icons are a representation of a respective attribute tag represented by a respective node of the search navigation graph.

### FIELD

The present disclosure is related to a search navigation system and method. In particular, the present disclosure is related to optimizing inventory searches for online stores based on attributes of the products.

### BACKGROUND

An e-commerce platform typically hosts many different online stores/service instances, providing services and functionalities to support typical operations of the online stores. E-commerce stores/platforms may provide functionality for searching products available from merchants, such as, for example, based on keywords.

### SUMMARY

When using conventional keyword search to search for products on online stores, customers may not always know or use the correct search terms to identify the products they are looking for. Some online stores allow for basic filtering using sidebars with drop-down menus and/or faceted search widgets. Notably, however, a customer may wish to identify a product based on attributes that are not encompassed by the standard drop-down menus or the faceted search widgets. Searching for a product based on these specialized or more subtle attributes, therefore, is extremely difficult without knowledge of the exact keywords. This problem may be further complicated by inconsistent product titles across different stores or even within the same store, and/or by product descriptions that do not fully or correctly represent the (in some cases, visual) attributes of the product.

Yet further, it is a problem that any given product that is available for sale typically has a large number of attributes in a variety of fields. The quantity of all the different possible attributes and facets cannot be presented to the customer with standard searching methods. Allowing for filtering based on the sheer volume of possible different attributes would either be non-intuitive or would take up too much space on the user interface.

Accordingly, it would be useful to provide methods and systems that provide more relevant results from inventory searches using more intuitive user inputs. In various examples, the present disclosure describes methods and systems for search navigation, including methods and systems that improve search navigation using a search navigation graph, such as a tree or a directed acyclic graph (DAG). Examples of the present disclosure further enable dynamically modifying a search navigation tree or template graph for each online store based on its product catalogue and available inventory levels. Conveniently, in this way, one or more of the deficiencies of conventional keyword based searching may be overcome and/or avoided.

In some examples, the present disclosure describes a search navigation system for an online store, the search navigation system comprising: a processing unit configured to execute instructions to cause the system to: obtain attribute tags associated with available inventory associated with the online store; detect a buyer event associated with the online store; in response to the buyer event, generate a search navigation graph for the online store based on a search navigation template graph, the search navigation graph comprising a hierarchical graph wherein each node in the search navigation graph represents a respective attribute tag, and wherein the search navigation graph includes only nodes of the search navigation template graph representing attribute tags associated with the available inventory associated with the online store; and cause a search navigation bar in a user interface to be displayed with selectable icons, the selectable icons each being a representation of a respective attribute tag represented by a respective node of the search navigation graph.

In some examples, the present disclosure describes a search navigation method for an online store, the method comprising: obtaining attribute tags associated with available inventory associated with the online store; detecting a buyer event associated with the online store; in response to the buyer event, generating a search navigation graph for the online store based on a search navigation template graph and the attribute tags, the search navigation graph comprising a hierarchical graph wherein each node in the search navigation graph represents a respective attribute tag, and wherein the search navigation graph includes only nodes of the search navigation template graph representing attribute tags associated with the available inventory associated with the online store; and causing a search navigation bar in a user interface to be displayed with selectable icons, the selectable icons each being a representation of a respective attribute tag represented by a respective node of the search navigation graph.

In some examples, the present disclosure describes a computer-readable medium storing instructions that, when executed by a processor of a system, cause the system to: obtain attribute tags associated with available inventory associated with the online store; detect a buyer event associated with the online store; in response to the buyer event, generate a search navigation graph for the online store based on a search navigation template graph and the attribute tags, the search navigation graph comprising a hierarchical graph wherein each node in the search navigation graph represents a respective attribute tag, and wherein the search navigation graph includes only nodes of the search navigation template graph representing attribute tags associated with the available inventory associated with the online store; and cause a search navigation bar in a user interface to be displayed with selectable icons, the selectable icons each being a representation of a respective attribute tag represented by a respective node of the search navigation graph.

In any of the above examples, generating the search navigation graph comprises pruning the search navigation template graph by removing a subgraph from the search navigation template graph, wherein the removed subgraph contains nodes representing attribute tags that are not associated with the available inventory associated with the online store.

In any of the above examples, generating the search navigation graph involves/includes shrinking the search navigation template graph by identifying a hierarchical level in the search navigation template graph that contains only a single node and removing the identified hierarchical level from the search navigation template graph.

In any of the above examples, generating the search navigation graph comprises promoting a node of the search navigation template graph by identifying the node as representing a attribute tag that is common to child nodes of two or more parent nodes at a common hierarchical level, and moving the identified common node to the common hierarchical level of the parent nodes.

In any of the above examples, generating the search navigation graph comprises performing the pruning, the shrinking, and the promoting iteratively until a convergence condition is satisfied.

In any of the above examples, in response to a change in the available inventory associated with the online store that changes the attribute tags associated with the available inventory, the search navigation graph is regenerated to correspond to the inventory change, and cause the search navigation bar on the user interface to be updated to correspond with the regenerated search navigation graph.

In any of the above examples, regenerating the search navigation graph in response to the change in the available inventory associated with the online store comprises repeating the pruning, the shrinking, and the promoting.

In any of the above examples, a copy of the search navigation graph in association with the online store is stored in memory after the search navigation graph is generated.

In any of the above examples, a filter is further applied to the available inventory, the search navigation graph is regenerated to correspond to the filtered inventory, and the search navigation bar on the user interface is updated to correspond with the regenerated search navigation graph.

In any of the above examples, the filter is associated with a particular page of the online store and the filter is applied to the available inventory associated with the online store when a customer navigates to the particular page of the online store.

In any of the above examples, the attribute tags are visual attribute tags associated with visual attributes of the available inventory associated with the online store.

In any of the above examples, wherein the change in the available inventory associated with the online store is a depletion of available inventory associated with a particular attribute tag, and regenerating the search navigation graph to remove the node representing the particular attribute tag causes the selectable icon corresponding to the particular attribute tag to become grayed-out in the search navigation bar.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of an example e-commerce platform, including a tagging module and a search graph generator, in which examples described herein may be implemented;

FIG. 4 is another block diagram of the e-commerce platform of FIG. 1, showing details related to the tagging module and the search graph generator;

FIG. 5 is an illustration of a product with its visual attributes tagged with attribute tags

FIG. 6 is a visual illustration of an example template graph;

FIG. 7 is a visual illustration of an example of pruning, shrinking, and promoting the template graph of FIG. 6;

FIG. 8 is a flowchart illustrating an example method for search navigation, including dynamically modifying a search navigation template graph for an online store based on product catalogue and available inventory levels; and

FIGS. 9A-9E illustrate example interfaces for performing a search using a search navigation bar that corresponds with the search navigation graph of the corresponding online store.

Similar reference numerals may have been used in different figures to denote similar components.

### DESCRIPTION OF EXAMPLE EMBODIMENTS

Visual search navigation (VSN) has been applied in the past for searching a product catalogue of an online store. However, building and maintaining a custom VSN tree for each product catalogue on an online marketplace is an arduous process. Not only does it require building a custom VSN tree for each product catalogue of an online store, it also requires manually updating the VSN tree each time the inventory changes for any given product. For example, each time a product is purchased, returned, or additional inventory is added, the VSN tree and relevant product category levels must be manually adjusted to reflect the change. Such requirements restrict the VSN tree's ability to be practical for implementation at larger scales or in real-time. For example, building a VSN tree for catalogues with a vast number of different products would itself be time consuming. As well, the large amount of manual maintenance that would be required to update all the nodes each time the inventory changes make real-time tracking of product inventory impractical, if not impossible, and thus not a realistic implementation option.

The present disclosure relates to search navigation using a search navigation (template) graph. Examples of the present disclosure further enable dynamically modifying the search navigation tree or template graph for each online store based on its product catalogue and available inventory levels, optionally in real-time. This provides customers with the ability to use attributes and cues (such as visual cues) in a search navigation bar that represents key product attributes to efficiently search for the product that they have in mind.

An example of an e-commerce platform configured to perform the above is described below. However, it should be understood that this discussion is only for the purpose of illustrating an example e-commerce platform and is not intended to be limiting as to the nature of an e-commerce system with which the subject matter of the present application may be implemented. Further, it should be understood that the present disclosure may be implemented in other contexts, and is not necessarily limited to implementation in an e-commerce platform. For example, the present disclosure may be implemented in the context of any other platform that supports service instances (e.g., a web hosting platform), without necessarily supporting any e-commerce. Other such possibilities are contemplated within the scope of the present disclosure.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

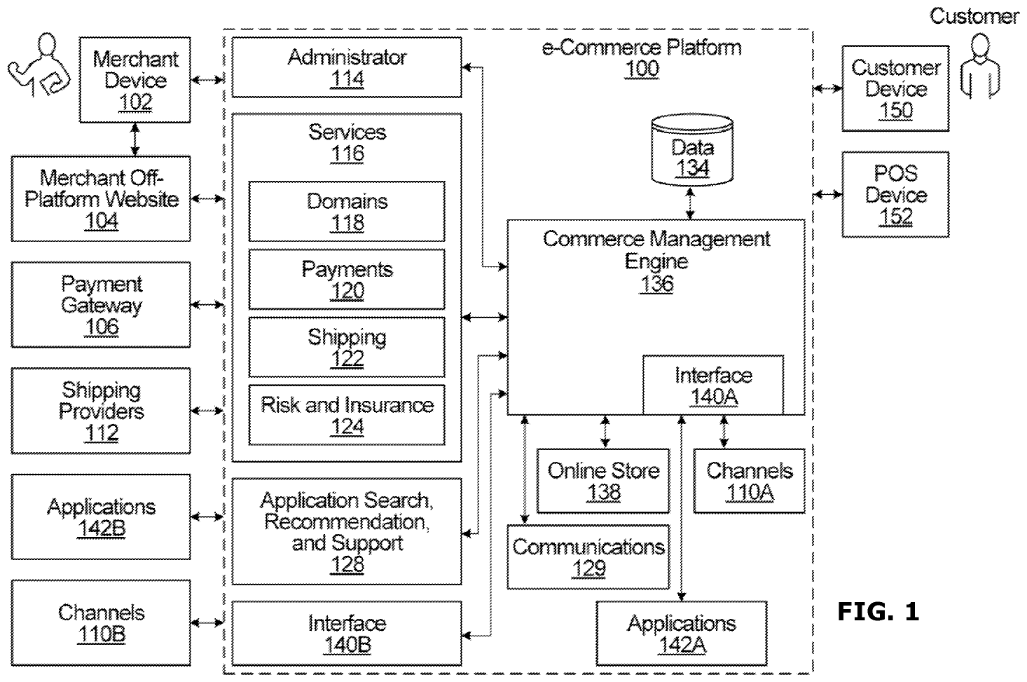

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

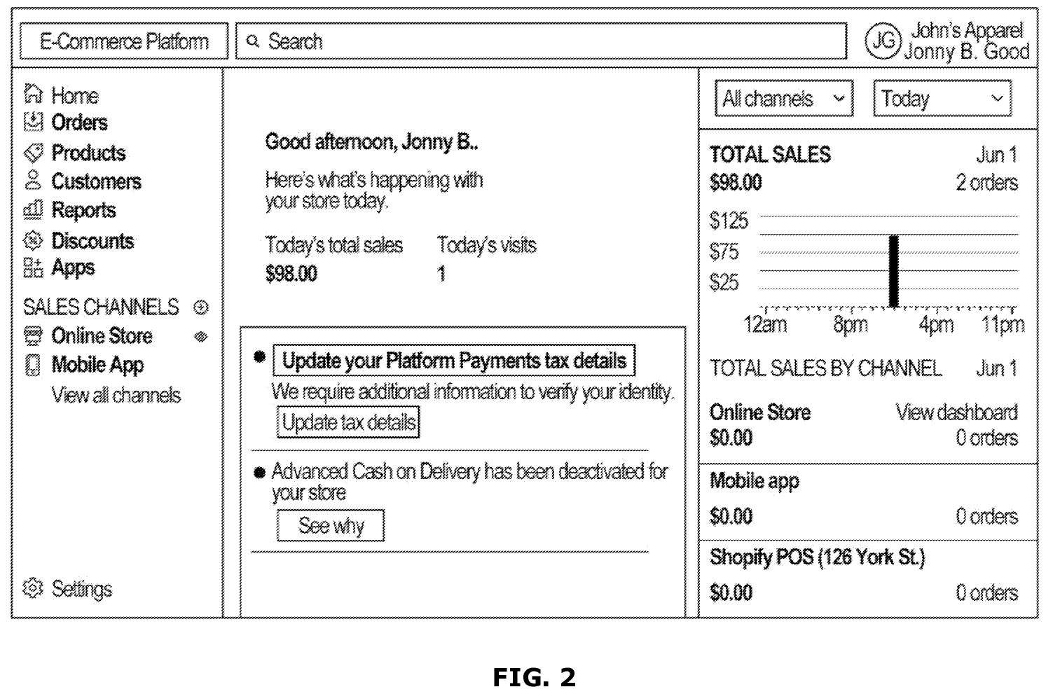

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalogue, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component.

Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

Implementation in an e-Commerce Platform

Having discussed an example e-commerce platform, we now turn to discussion of methods of providing improved searching such as, may be employed, in association with such platforms. For example, the functionality described herein may be used in commerce to provide improved customer or buyer experiences. Accordingly, systems and methods for providing improved search will be described in the context of e-commerce including how such an improved search may, in at least some embodiments, be implemented as a component of and/or in concert with an e-commerce platform. However, in other implementations, such improved search functionality may be employed in e-commerce/commerce applications without integration into the e-commerce platform. For example, a search app might be provided as could allow searching e-commerce stores/products. More broadly, however, it is noted that such improved searching is not limited to the commerce/e-commerce context and it may, for example, be employed in contexts other than e-commerce without departing from the subject matter of the present invention.

Turning now to the discussion of the improved searching in association with the e-commerce platform 100, it is first noted that the e-commerce platform 100 could implement the functionality for any of a variety of different applications, examples of which are described elsewhere herein. In particular, examples of the present disclosure describe functionality of the e-commerce platform 100 to enable tagging of product attributes and generation of search graphs for online stores. For example, the e-commerce platform 100 may tag products using a tagging module 350, and generate search graphs using a search graph generator 360.

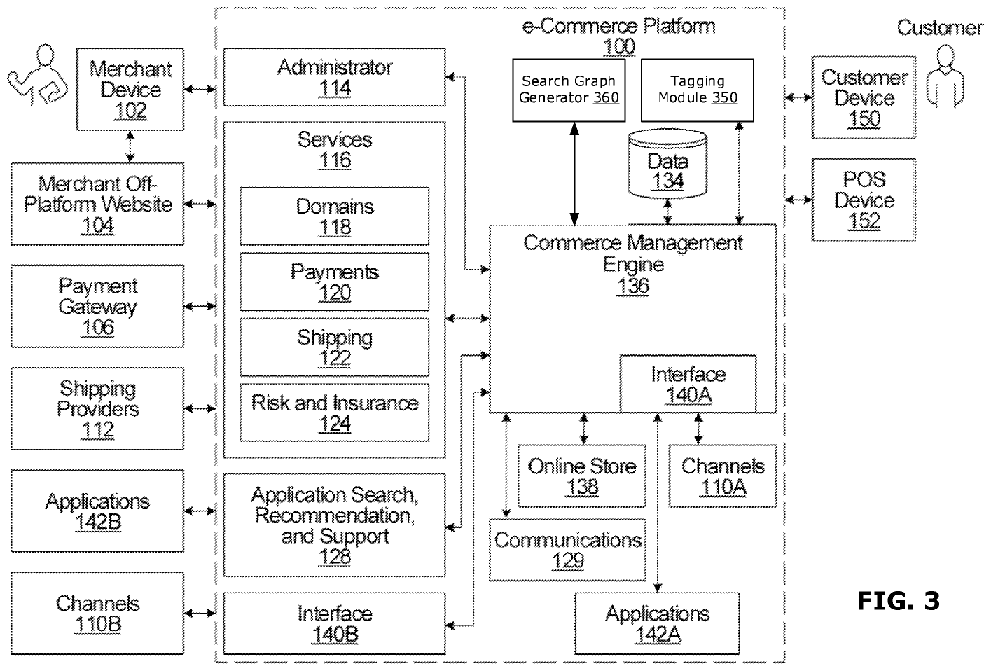

FIG. 3 illustrates the e-commerce platform 100 of FIG. 1 but including the tagging module 350 and the search graph generator 360. Further details of the tagging module 350 and the search graph generator 360 are discussed further below.

Although the tagging module 350 and the search graph generator 360 are illustrated as distinct components of the e-commerce platform 100 in FIG. 3, this is only an example. The tagging module 350 and the search graph generator 360 could also or instead be provided by another component residing within or external to the e-commerce platform 100. In some embodiments, either or both of the applications 142A-B may provide an embodiment of the tagging module 350 and the search graph generator 360 that implement the functionality described herein. The location of the tagging module 350 and the search graph generator 360 may be implementation specific.

In some implementations, the tagging module 350 and the search graph generator 360 may be provided at least in part by the e-commerce platform 100, either as a core function of the e-commerce platform 100 or as one or more applications or services supported by or communicating with the e-commerce platform 100. For simplicity, the present disclosure describes the operation of the tagging module 350 and the search graph generator 360 when the tagging module 350 and the search graph generator 360 are implemented in the e-commerce platform 100, however this is not intended to be limiting. For example, at least some functions of the tagging module 350 and the search graph generator 360 may by additionally or alternatively be implemented on the customer device 150.

In some implementations, the examples disclosed herein may be implemented using a different platform that is not necessarily (or is not limited to) the e-commerce platform 100. In general, examples of the present disclosure are not intended to be limited to implementation on the e-commerce platform 100.

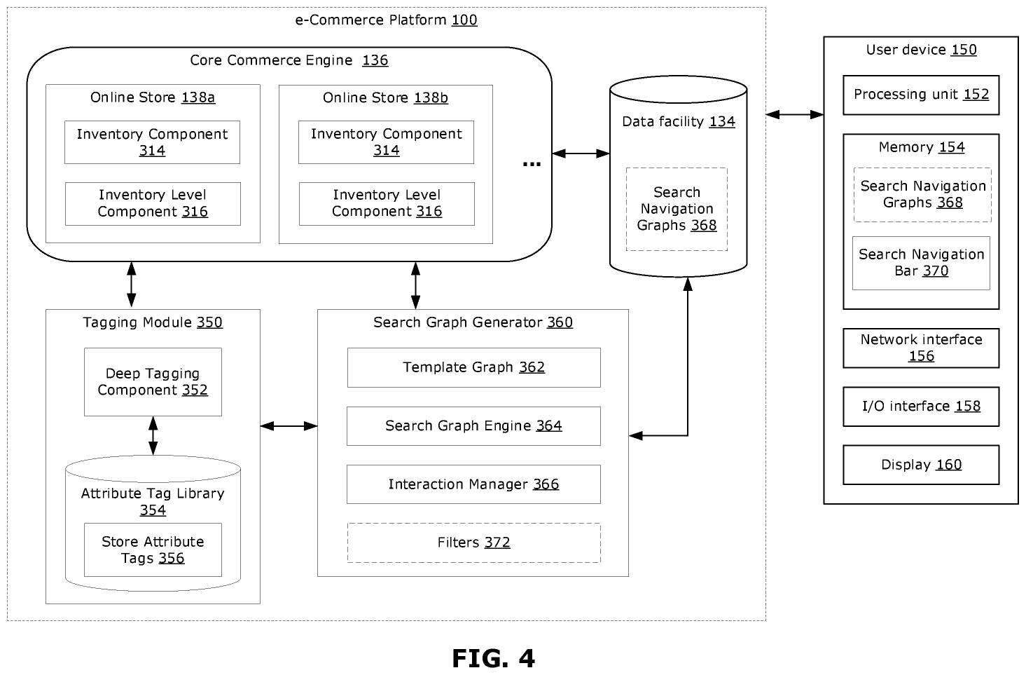

FIG. 4 is another depiction of the e-commerce platform 100 that omits some details that have been described with reference to FIG. 1, and shows further details discussed below. In particular, FIG. 4 illustrates some example details of the e-commerce platform 100 that are relevant to optimizing inventory searches of products sold by an online store. Some details of the e-commerce platform 100 are not shown, to avoid clutter. FIG. 4 illustrates other computing systems interacting with the e-commerce platform 100, including a user device 150.

The user device 150 may be any electronic device capable of displaying a user interface. Examples of suitable electronic devices include wearable devices (e.g., head-mounted display (HMD) devices, AR glasses, smart watches, etc.) and/or mobile devices (e.g., smartphones, tablets, laptops, etc.), among others. Examples of the present disclosure may also be implemented in non-wearable devices and/or non-mobile devices, such as desktop computing devices, workstations, tracking systems, and other computing devices. Example components of the user device 150 are now described, which are not intended to be limiting. It should be understood that there may be different implementations of the user device 150.

The shown user device 150 includes at least one processing unit 152, such as a processor, a microprocessor, an application-specific integrated circuit (ASIC), a field-programmable gate array (FPGA), a dedicated logic circuitry, a graphics processing unit (GPU), a central processing unit (CPU), a dedicated artificial intelligence processor unit, or combinations thereof.

The user device 150 includes at least one memory 154, which may include a volatile or non-volatile memory (e.g., a flash memory, a random access memory (RAM), and/or a read-only memory (ROM)). The non-transitory memory 154 may store instructions for execution by the processing unit 152, such as search navigation graphs 368 (as will be further described below).

The user device 150 includes at least one network interface 156 for wired or wireless communication with an external system or network (e.g., an intranet, the Internet, a P2P network, a WAN and/or a LAN), and in particular for communication with the e-commerce platform 100 in the example shown.

The user device 150 also includes at least one input/output (I/O) interface 158, which interfaces with input and output devices. In some examples, the same component may serve as both input and output device (e.g., a display 160 may be a touch-sensitive display). The user device 150 may include other input devices (e.g., buttons, microphone, touchscreen, keyboard, etc.) and other output devices (e.g., speaker, vibration unit, etc.).

Returning to commerce platform 100, FIG. 4 illustrates the e-commerce platform 100 with multiple online stores 138a, 138b etc. Each online store of the commerce management engine 136 may be associated with one of multiple merchants via merchant devices 102. As noted above, each online store 138a, 138b has an inventory component 314, and an inventory level component 316, which may be software components. Inventory component 314 may record where products are stocked for the online store, and track quantities of products. Inventory level component 316 may keep track of quantities of products that are available for sale by the corresponding online store, low stock, committed to an order, or incoming from an inventory transfer component (e.g., from a vendor) etc.

The e-commerce platform 100 may first include a tagging module 350 that is in communication with the online stores 138a, 138b. Products in a catalogue of an online store may be tagged according to their attributes, such as their visual attributes. The attributes may relate to broad categories, such as the intended gender that the product was produced for, and the type of the product, such as pants, dresses, accessories etc. The attributes may also relate to more specific categories, such as the color or the material of the product. The products in the catalogue may also be tagged according to non-visual attributes, such as functional features.

The tagging module 350 is shown to have a memory storing an attribute tag library 354 which contains attribute tags. The attribute tag library 354 is a library of tags associated with possible attributes of products for the online stores (138a, 138b). In that regard, the attribute tag library 354 may include both visual and non-visual attribute tags.

The attribute tag library 354 is populated with attribute tags that may be defined by domain experts or professionals in a given field who have expertise in determining what the important and distinct features of a product in the given field are. They may determine the attributes of importance for commonly sold products in the field.

For example, in the fashion industry, professional stylists with expertise in determining the important and distinct visual features of clothing products, may determine the visual attributes of importance for common clothing products. The domain experts or professional stylists may determine that the sleeve length is an important feature for dresses. Thus, attribute tags may include “long sleeves”, “mid-length sleeves”, “short sleeves”, and “off shoulder” etc. The attribute tags may also include broader and narrower categories of attributes. For example, a women's boot may be tagged with “Woman”, “Shoe”, “Boot”, “Brown”, and “No Heel”.

One or more attribute tags that are stored in the attribute tag library 354 may be assigned to each product (also referred to as “tagging” the product) in a product catalogue of an online store 138a, 138b. The tagging may be accomplished manually or by a trained machine-learning model. In the case of manual tagging, the tagging module 350 may be configured to receive input from the merchant device 102 selecting attribute tags to assign to a given product as the merchant performs the manual tagging for the products in the catalogue of the merchant's online store 138a, 138b.

In the case of machine tagging, the tagging module 350 may further include a deep tagging component 352. The deep tagging component 352 may be configured to extract visual attributes of catalogue items using a machine learning (ML) image recognition model. The ML model may have been trained (e.g., using supervised learning) to recognize a product category from an image of a product in a product catalogue, and to predict the attribute tag(s) that should be assigned to the product. In this regard, the ML model may be trained to process product images to infer the visual attribute tags that should be assigned to each image. In such a case, the ML model may process all the images in a product catalogue and automatically annotate the products with tags that describe each product's visual attributes (such as color, length, style, etc.). In some examples, ML-based tagging may be supplemented or checked by humans.

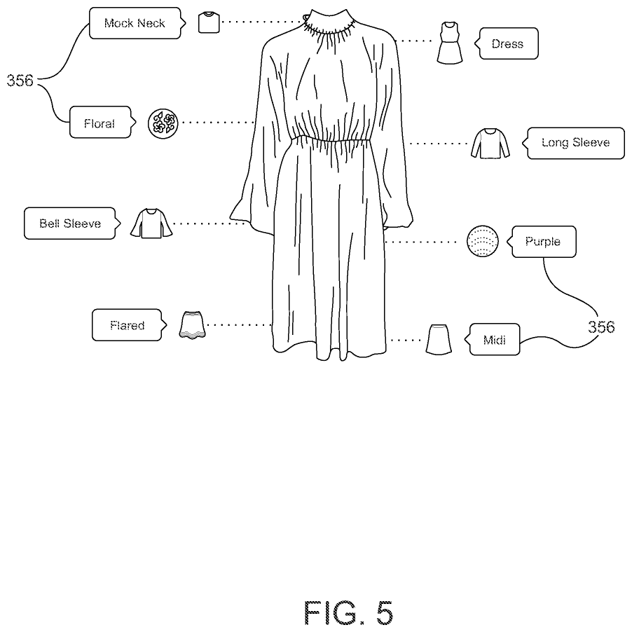

For example, as shown in FIG. 5, the product (in the example shown, a dress) may be tagged with visual attributes: “Dress”, “Mock Neck”, “Purple”, “Floral”, “Long Sleeve”, “Bell Sleeve”, “Midi”, and “Flared”. These visual attribute tags may be either received by the tagging module 350 from a merchant device 102 or generated by the deep tagging component 352. In either case, the attribute tags associated with the products in each online store's 138a, 138b product catalogue may be stored in memory as store attribute tags 356.

In order to generate a search navigation graph for each online store to navigate its product catalogue, the e-commerce platform 100 further includes a search graph generator 360 that is in communication with the tagging module 350 and the online stores 138a, 138b. The search graph generator 360 is configured to generate a search navigation graph for each online store 138a, 138b using a template graph 362, a search graph engine 364, and an interaction manager 366.

The template graph 362 may be designed by the aforementioned domain experts, who are experts in a given industry (e.g. fashion, home décor etc.). This template graph 362 generally contains nodes representing a large variety of common parent or broad categories, subcategories under each broad category, and further subcategories that categorize various attributes. The nodes representing the various categories and subcategories are arranged into predefined hierarchical levels of relevance by the domain experts. Thus, the search navigation template graph is a hierarchical graph, in which a node representing a broader category of attributes (e.g., node representing “color”) is a parent node to a child node representing subcategories within the broader category (e.g., child nodes representing specific colors, such as “red”, “blue”, and “white”). It should be noted that, unlike a tree structure, the hierarchical graph may include a child node that has two or more different parent nodes. For example, a node representing the attribute “long sleeve” may be a child node of parent node “blouse” and parent node “shirt”.

The following is an example of navigation hierarchy levels of a search navigation template graph 362 for the fashion and apparel industry, arranged according to relevance:

Level 1: women/men/girls/boys/baby

Level 2: suit/ring/scarf/shoe/shorts/skirt/sleepwear/socks/pants

Level 3: type/color/pattern, etc.

Level 4: [subcategory of type] flats/trainers/boots/slippers

Level 5: [subcategory of boots] boot type/boot height/toe shape/heel height

Level N: [subcategory of selection made in previous level]

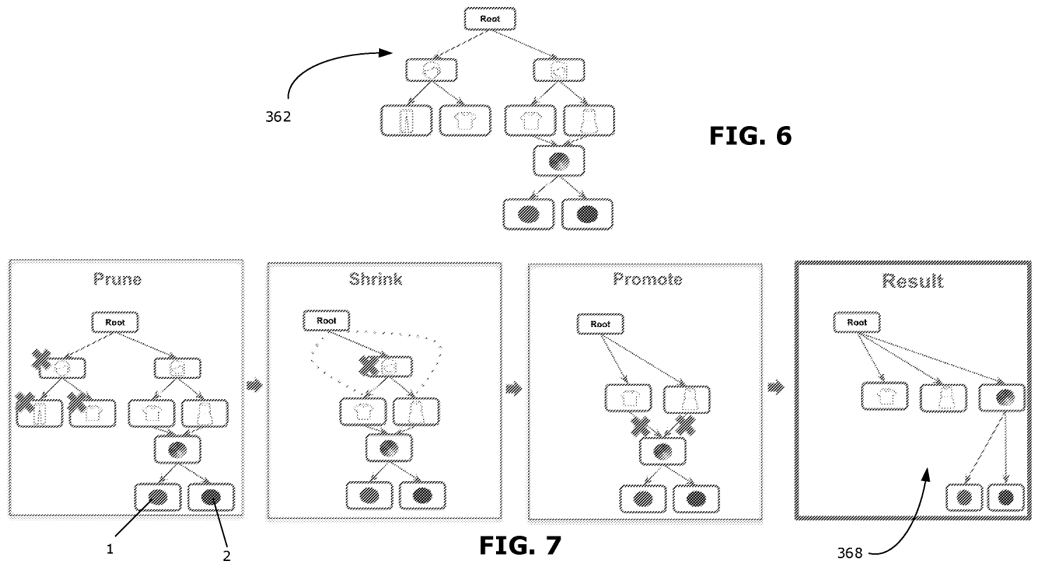

FIG. 6 provides a visual illustration of a simplified example of a template graph 362. In this example, the simplified template graph 362 is for searching fashion products.

The search graph engine 366 is configured to customize the template graph 362 for each online store 138a, 138b based on the product inventory and store attribute tags 356 associated with the online store's inventory. The search graph engine 364 is thus configured to generate a customized search navigation graph 368 for each online store 138a, 138b based on the store attribute tags 356 for each online store 138a, 138b. In that regard, the search navigation graph 368 for each online store 138a, 138b contains only nodes representing the store attribute tags 356 that are associated with the available inventory associated with the respective online store 138a, 138b. To do so, the search graph engine 364 is configured to perform a “Prune, Shrink, and Promote” approach based on the available inventory associated with the particular online store. The search graph engine 364 may be configured to perform the approach iteratively. FIG. 7 provides a visual illustration of an example of the Prune, Shrink, and Promote approach described below.

The search graph engine 364 may be first configured to “prune” the template graph 362 by removing a subgraph from the template graph 362. The subgraph to be removed contains nodes representing attribute tags that are not associated with the available inventory associated with the corresponding online store 138a, 138b. For example, as shown in FIG. 7, if an online store only sells women's clothing, the “Men” node, and all the subsequent nodes specific to “Men” in the subgraph, would be removed or “pruned” from the template graph 362.

The search graph engine 364 may then be configured to “shrink” the template graph 362 by removing any single-node levels leftover from the Pruning. To that end, a hierarchical level that only contains a single node is identified by the search graph engine 364. The identified hierarchical level may be then removed from the template graph 362. For example, if only the “Women” node is left in its hierarchical level, it would be removed from the template graph 362, and it would (effectively) be replaced with subsequent nodes from the level below, such as “Ring”, “Scarf”, “Shoes”, “Shorts”, “Skirts”, “Sleepwear”, “Socks, and “Pants” (see FIG. 7).

The search graph engine 364 may be subsequently configured to identify a node as representing an attribute tag that is common to child nodes of two or more parent nodes (the parent nodes being at a common hierarchical level). Since there is no need to provide the common child node separately, the search graph engine 364 may move or “promote” the identified common node to the common hierarchical level of the parent nodes. For example, see FIG. 7, if one level contains only dresses and tops (i.e. dresses and tops being the parent nodes at a common hierarchical level), and the dresses and tops are only available in either blue or red (i.e. the common child nodes, and indicated respectively as 1 and 2 in FIG. 7), the color node would be moved or “promoted” to the same common hierarchical level as the dresses and tops. This may be the case as there is no need to show the choice between dresses and tops before showing their available colors.

The search graph engine 364 may further be configured to perform the “Pruning”, “Shrinking” and “Promoting” steps iteratively (where a single iteration may be defined as performing one sequence of the pruning, shrinking and promoting operations) or multiple times until a convergence condition is satisfied. Upon satisfaction of the convergence condition, the resulting search navigation graph 368 is considered to be generated. One example of a convergence condition is when the resulting graph from a current iteration of the “pruning, shrinking and promoting” is the same as the result graph from a previous iteration. Another example of a convergence condition is requiring the search graph engine 364 to perform the “Pruning”, “Shrinking” and “Promoting” steps up to a maximum number of iterations.

While the “Pruning”, “Shrinking” and “Promoting” steps have been described to be performed iteratively in that order, in certain applications, the search graph engine 364 may alternately be configured to perform only one or two of the three operations on the template graph 362 to generate a search navigation graph 368 for a particular online store. The one or two operations may then be performed iteratively as described above. The search graph engine 364 may also alternately be configured to perform the “Pruning”, “Shrinking” and “Promoting” operations in a different order.

The above steps may be applied to the template graph 362 by the search graph engine 364 when the interaction manager 366 detects one or more trigger events, such as a buyer event and/or an inventory event associated with the online store 138a, 138b. To that end, the interaction manager 366 may communicate with the user devices 150 to detect or receive indication of the buyer event, and may communicate with the inventory component 314 and inventory level component 316 to detect or receive indication of the inventory event. The interaction manager 366 is, thus, configured to instruct the search graph engine 364 to generate or regenerate the search navigation graph 368 upon detection of a trigger event, such as a buyer event or an inventory event.

The buyer event may be an action on the online store 138a, 138b that is initiated by a buyer or potential customer (e.g., via the user device 150). For example, the buyer event may be a purchase event of a product from the online store 138a, 138b, or it could simply be the customer viewing a (product) page on the online store 138a, 138b. The inventory event may be an action on the online store 138a, 138b that is initiated by the corresponding merchant or by changes in product inventory. For example, the inventory event may be an inventory increment event when new inventory is added by the merchant, an inventory decrement event when a customer purchases a product, an inventory decrement below a given threshold event, a product return event, a fulfillment event, or when the merchant adds new products to their product catalogue etc.

The search graph generator 360 may be further configured to save the generated search navigation graph 368 for future use or reference each time after it is generated and/or updated. The generated search navigation graph 368 may be saved locally in the data facility 134 on e-commerce platform 100, or remotely in the memory 154 of the user device 150. Saving the search navigation graph 368 in the data facility 134 of e-commerce platform 100 may be performed if the trigger event is a buyer or an inventory event. Saving the search navigation graph 368 in the memory 154 of the user device 150 may be performed if the trigger event is a buyer event.

The search graph generator 360 is further configured to cause or instruct the user device 150 to display a search navigation bar 370 (perhaps stored in the memory 154) with selectable icons on a user interface on the display 160. The selectable icons on the search navigation bar 370 are each a representation of a respective attribute tag represented by a respective node of the search navigation graph 368. In this manner, a customer can visually understand attributes of the products without needing to know or understand the exact textual description of the attribute. The selectable icons may be any representation of the corresponding attribute, including descriptive text.

As noted above, the interaction manager 366 may be in communication with the inventory component 314 and inventory level component 316 to detect or receive indication of an inventory event at the online store 138a, 138b. As noted above, the inventory event may be an inventory increment event when new inventory is added by the merchant, an inventory decrement event when a customer purchases a product, an inventory decrement below a given threshold event, a product return event, a fulfillment event, or when the merchant adds (or is expected to add) new products to their product catalogue etc.

In that regard, a change in inventory may also change the store attribute tags 356 associated with the available inventory. For example, new product(s) added to the product catalogue may introduce new attribute tag(s) that were not associated with existing products. In other cases, depletion of a product may mean that attribute tag(s) that were assigned to that product, but not to other products in the catalogue, are no longer associated with available inventory.

Upon detection of a change in the available inventory associated with the online store 138a, 138b, which may also involve a change in the store attribute tags 356 associated with the available inventory, the search graph generator 360 may be configured to regenerate or update the search navigation graph 368 to correspond to the change in inventory and/or change in store attribute tags. The search graph engine 364 may be configured to regenerate the search navigation graph 368 by repeating the pruning, the shrinking, and the promoting described above with the updated store attribute tags 356 (e.g., until the search navigation graph 368 converges on an updated search navigation graph 368). The search graph generator 360 may then be configured to cause the search navigation bar 370 to be updated to correspond with the regenerated search navigation graph 368.

The search graph generator 360 may further comprise filters 372 that may be applied to the available inventory of the online store 138a, 138b by the search graph engine 364 prior to generation of the search navigation graphs 368. The filters 372 may be defined by the merchants of the online store 138a, 138b and/or by the search graph generator 360, and function to separate a (sub)category of products from the rest of the inventory based on an attribute of the product. The attribute may be one that is not related to an intrinsic property of the product itself. For example, the filter 372 may be a “SALE” filter, a “Promotion” filter, a “Recommended” filter, or a “Members-only” filter etc.

The filters 372 may be associated with particular pages of the online store 138a, 138b and the search graph engine 364 may be further configured to apply one of the filters 372 to the available inventory associated with the online store 138a, 138b when a customer navigates to the particular corresponding page of the online store 138a, 138b (as detected by the interaction manager 366). In that regard, when a customer does navigate to a particular page of the online store 138a, 138b that is associated with a filter, the filter 372 is applied to the available inventory to separate out the products (from the rest of the inventory) based on the particular attribute defined by the filter.

The search graph engine 364 may then further be configured to regenerate the search navigation graph 368 to correspond to the filtered inventory, and to cause the search navigation bar 370 on the display 160 to be updated to correspond with the regenerated search navigation graph 368.

The automatic generation and update of the search navigation graphs 368 for each online store, each with more intuitive and reduced attribute tags, helps to minimize the number of inputs the customer must enter in order to search the available inventory and find the product he or she is looking for. In this manner, processing power is saved since the processor has fewer inputs to process before the desired outcome is achieved. This may be particularly beneficial in the case where the user device 150 has limited resources (e.g., is a handheld mobile device, which typically has fewer computer resources compared to desktop devices). The present system also helps to speed up the search process for the customer when browsing the online store 138a, 138b.

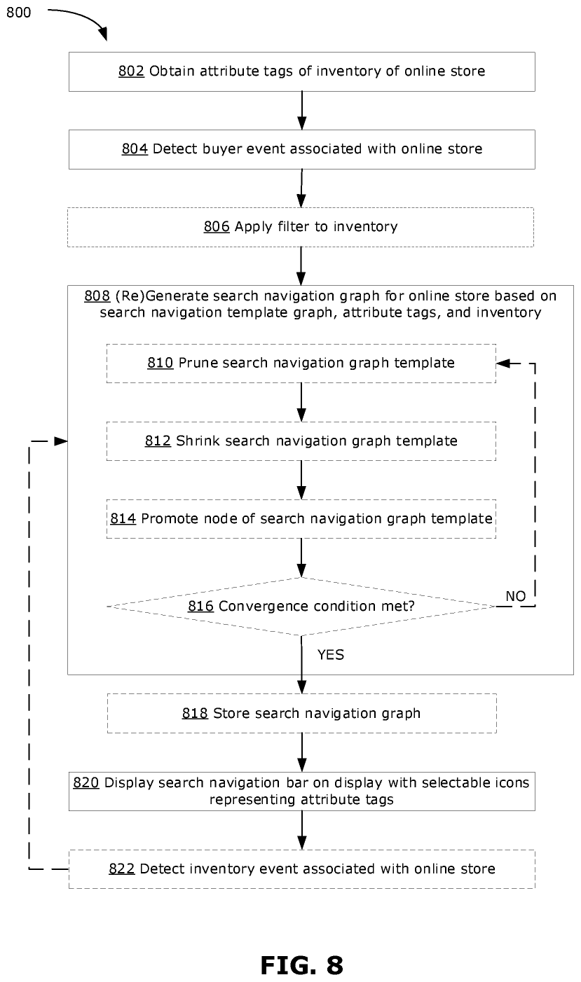

FIG. 8 is a flowchart illustrating an example method 800 for searching and navigating through product inventory for an online store. The example method 800 may be performed by the e-commerce platform 100 using the tagging module 350 and the search graph generator 360, for example. In particular, the method 800 may be performed in real-time (or near real-time) while a customer is browsing on a given online store 138a, 138b.

At an operation 802, attribute tags of the inventory of the online store 138a, 138b may be obtained. As noted above, the attribute tags associated with the products of a given online store may be referred to as the store attribute tags 356. The tagging may be accomplished manually or by a trained machine-learning model. In the case of manual tagging, the tagging module 350 may be configured to receive attribute tags from the merchant devices 102. In the case of machine tagging, the deep tagging component 352 of tagging module 350 may analyze images of the products and assign attribute tags to the images.

At an operation 804, a buyer event associated with the online store is detected. The buyer event may be an action on the online store 138a, 138b that is initiated by a buyer or potential customer (e.g., using inputs to the e-commerce platform 100 via the user device 150). For example, the buyer event may be a purchase event of a product from the online store 138a, 138b, or it could simply be the customer viewing a (product) page on the online store 138a, 138b. For example, when a customer first arrives at the online store 138a, 138b, the user device 150 makes a request to view a page of the online store 138a, 138b. This request may be detected as the buyer event.

Optionally, at an operation 806, a filter may be applied to the product inventory of the online store based on a particular buyer event. For example, the customer may navigate to a specific subpage on the online store 138a, 138b, such as a SALE page. However, an attribute like “sale” (for a product, for example) may not be an attribute that can be identified based on the qualities of the product itself. Thus, when the customer navigates to a sale page, an initial “SALE” filter may first be applied to the available inventory associated with the online store 138a, 138b. The customer may also navigate to a different subpage on the online store 138a, 138b, such as a denim subpage or a petite section subpage. In those instances, a different filter may alternatively or additionally be applied to the available inventory associated with the online store 138a, 138b. This additional filtering step uses the customer's navigation inputs to more efficiently search for the product that the customer has in mind. A merchant could configure their webpage so that the following 808 operation runs with an initial filter to tailor the search navigation graph 368 to a particular subpage, allowing for a combination of navigation methods.

At operation 808, a search navigation graph 368 may be generated for the online store 138a, 138b based on the search navigation template graph 362 and the store attribute tags 356 when a buyer event is detected. As noted above, the search navigation graph 368 comprises a hierarchical graph where each node represents a respective attribute tag, and where the search navigation graph 368 includes only nodes representing attribute tags that are associated with the available inventory associated with the corresponding online store. If the inventory was filtered at operation 806, search navigation graph 368 may be generated to reflect the filtered inventory, for example, using only products tied to the sale.

The search navigation graph 368 may be generated using one or more of a pruning (operation 810), shrinking (operation 812), and promoting (operation 814) steps (see FIG. 7).

At the operation 810, the search navigation template graph 362 is pruned by removing one or more subgraphs therefrom. The removed subgraphs contain nodes representing attribute tags that are not associated with the available inventory associated with the online store 138a, 138b.

At the operation 812, the search navigation template graph 362 is shrunk by identifying a hierarchical level in the search navigation template graph 362 that contains only a single node, and removing the identified hierarchical level from the search navigation template graph.

At the operation 814, a node of the search navigation template graph 362 is identified as representing an attribute tag that is common to child nodes of two or more parent nodes at a common hierarchical level. The identified common node is then moved or “promoted” to the common hierarchical level of the parent nodes.

The graph that results, or is generated, from the above operations may be the search navigation graph 368 for the corresponding online store. Method 800 may, however, include performing the pruning, the shrinking, and the promoting iteratively and/or multiple times until a convergence condition is satisfied in order to generate the search navigation graph 368. To that end, at an operation 816, it is determined whether the convergence condition has been met. If not, the method 800 returns to the operation 810. As noted above, an example of a convergence condition is when the resulting graph from a current iteration of the “pruning, shrinking and promoting” is the same as the result graph from a previous iteration. In other words, applying the pruning, shrinking, and promoting steps would no longer change the nodes in the graph. Another example of a convergence condition is requiring the search graph engine 364 to perform the “Pruning”, “Shrinking” and “Promoting” steps up to a maximum number of iterations.

If at an operation 816, it is determined that the convergence condition has been met, the method 800 continues. Optionally, at operation 818, the generated search navigation graph 368 may be stored for future use or reference. For example, if the customer returns to the same online store 138a, 138b, and the state of the store has not changed, then the saved search navigation graph 368 may be used, rather than generating a new one. A copy of the search navigation graph 368 may be stored locally on the e-commerce platform 100, such as on data facility 134. Alternatively, a copy of the search navigation graph 368 may be stored remotely, such as in the memory 154 of the user device 150.

At an operation 820, the method 800 further includes causing a search navigation bar 370 with selectable icons to be displayed on a user interface of the user device 150. The selectable icons are each a representation of a respective store attribute tag 356 represented by a respective node of the search navigation graph 368.

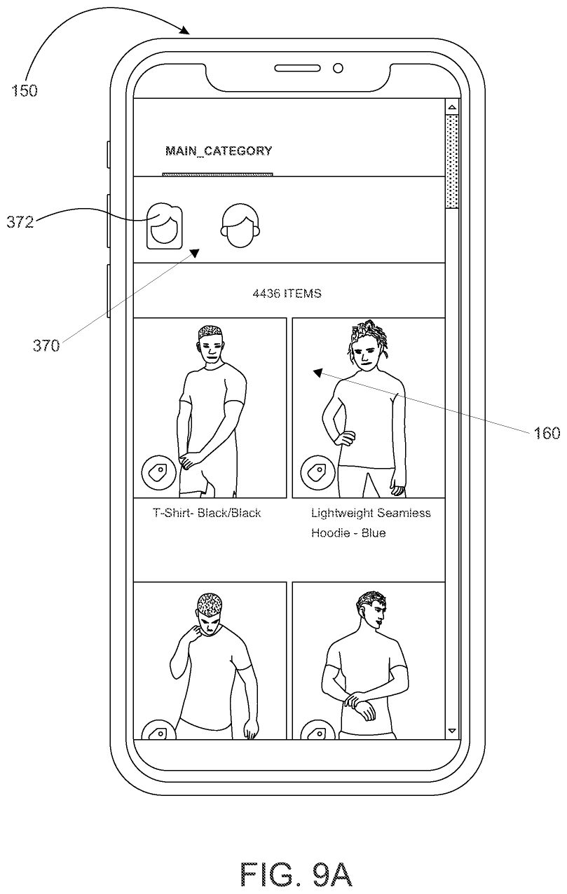

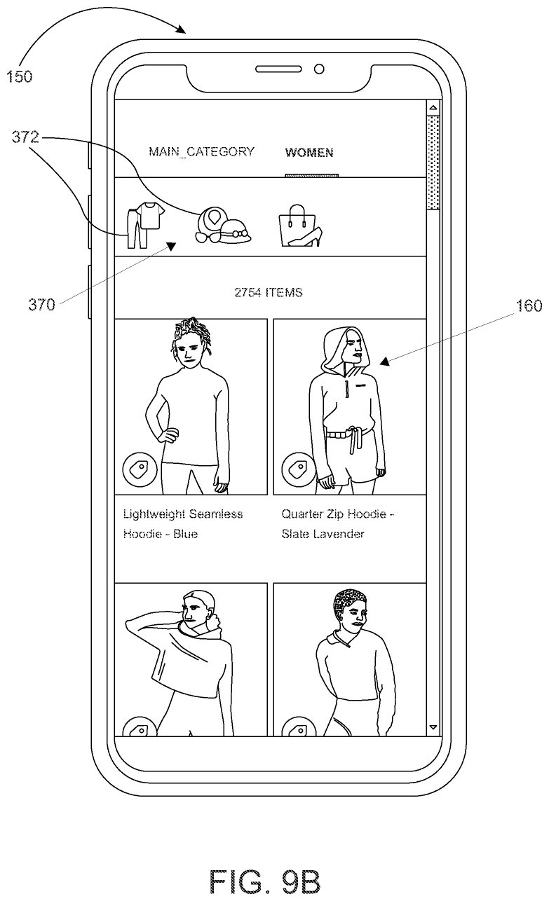

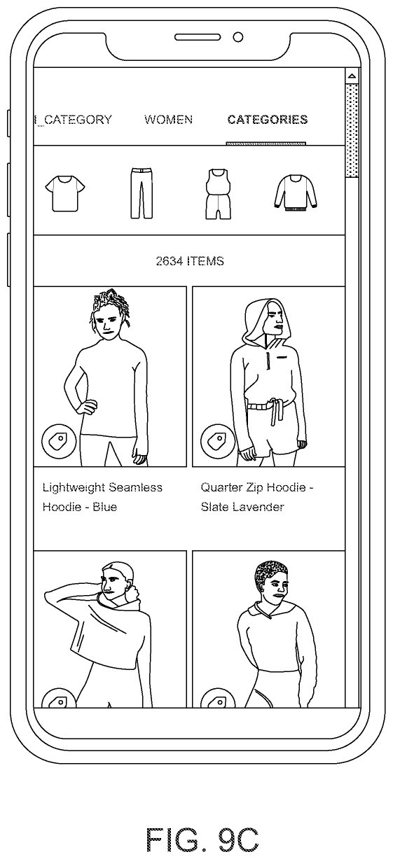

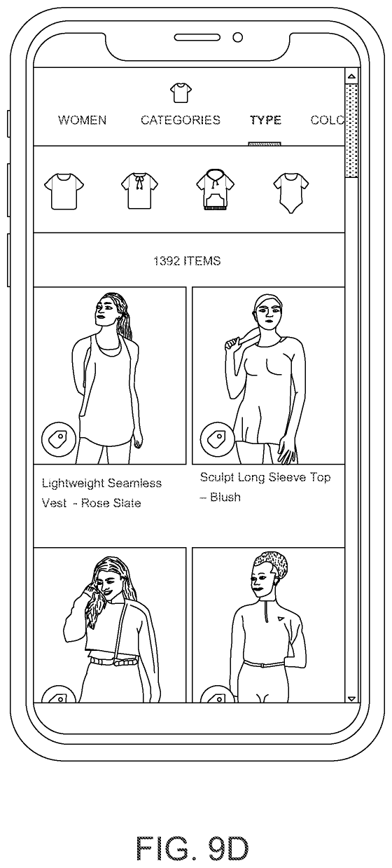

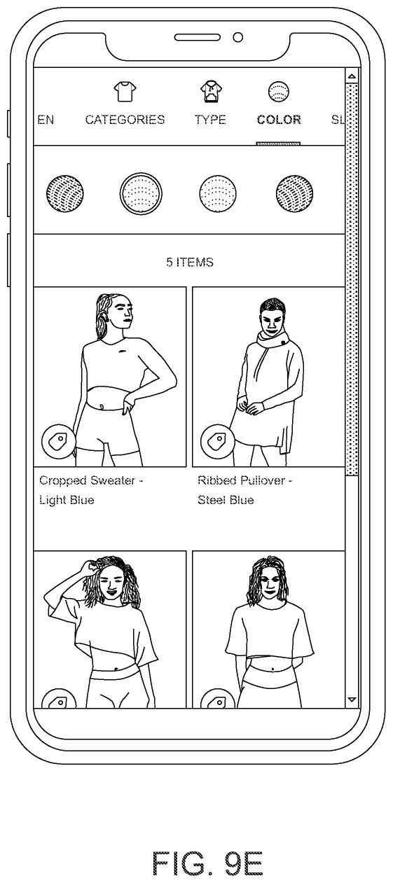

An example of the search navigation bar 370 with selectable icons 372 displayed on the display 160 of a user device 150 is illustrated in FIGS. 9A to 9E. In the illustrated example, only the icons 372 belonging to a single hierarchical level are selectable in the search navigation bar 370 at any time. The search navigation bar 370 reflects the structure of the search navigation graph 368 and displays selectable icons 372 associated with each node.

For example, as shown in FIG. 9A, the search navigation bar 370 displays selectable icons 372 associated with the “Men” node and the “Women” node. If the “Women” icon 372 is selected by the customer (see FIG. 9B), the search navigation bar 370 displays selectable icons 372 associated with the subsequent hierarchical level. In the example of FIG. 9B, the subsequent hierarchical level covers the “Type” of Women's products: “tops and bottoms”, “jewelry and head accessories”, and “bags and shoes”. If the “tops and bottoms” icon 372 is selected by the customer (see FIG. 9C), the search navigation bar 370 displays selectable icons 372 associated with the subsequent hierarchical level, i.e. the types of tops and bottoms. If the “tops” icon 372 is selected by the customer (see FIG. 9D), the search navigation bar 370 displays selectable icons associated with the subsequent hierarchical level, i.e. the types of tops. If one of the types of tops icon is selected by the customer (see FIG. 9E), the search navigation bar 370 displays selectable icons 372 associated with the subsequent hierarchical level, for example the color options for the selected type of top. Further hierarchical levels covering different categories and subcategories of nodes may also be included.

The generation of the search navigation graph (by pruning, shrinking, and promotion, and taking into account the available inventory) reduces the number of icons/nodes the customer must click through in order to find the desired product. Thus, the customer may find their desired product quicker, without having to go through irrelevant products. This helps to speed up the search process for the customer when browsing the online store. Processing power may also be saved, since the processor has fewer inputs to process before the desired outcome is achieved. This may be particularly beneficial in the case where the customer device 150 has limited resources (e.g., is a handheld mobile device, which typically has fewer computer resources compared to desktop devices).

The above steps may be applied in real-time or near real-time and in response to changes in inventory levels. Thus, at an operation 822, a change in inventory levels of the online store 138a, 138b may be detected, such as an inventory event. As noted above, the inventory event may be an action on the online store 138a, 138b that is initiated by the corresponding merchant or by changes in product inventory. For example, the inventory event may be an inventory increment event when new inventory is added by the merchant, an inventory decrement event when a customer purchases a product, an inventory decrement below a given threshold event, a product return event, a fulfillment event, or when the merchant adds new products to their product catalogue etc. In other words, the inventory of the available products may change when one or more of the available products is purchased, recalled, when new stock of the available products is added, and/or when new products are added to the product catalogue.

Thus, at the operation 822, when a change in the available inventory associated with the online store 138a, 138b is detected that also changes the attribute tags associated with the available inventory, the search navigation graph 368 may be regenerated (method 800 returns to operation 808) to correspond to the inventory change. The search navigation graph 368 may be regenerated by repeating the pruning (810), the shrinking (812), and the promoting (814) steps described above. As well, the search navigation bar 370 will also be updated to reflect the regenerated search navigation graph 368 and be displayed on the user interface (on the display 160 of the user device 150).

If a purchase is made on the online store 138a, 138b by one customer and the inventory level for that product is accordingly decremented, the search navigation graph 368 may be updated to reflect the currently available inventory for that customer as well as other customers who may be browsing. For example, returning to FIG. 7, if the online store sells its last red clothing item to the one customer, then the red attribute tag would no longer be necessary. In that case, the red node would be pruned (at operation 810), the blue node would be shrunk (at operation 812), and the resulting regenerated search navigation graph 368 would only contain tops and dresses in a single node. The search navigation bar 370 for the rest of the browsing customers may then be updated to reflect the regenerated search navigation graph 368, thus providing up-to-date search navigation information to the browsing customers. The search navigation graph 368 and the search navigation bar 370 may be updated as described above in real-time, in near real-time, or after a specified time interval has passed.

Browsing a store's product catalogue is an action that is often performed quickly by a customer. Thus, updating search navigation graphs/trees in response to a buyer/inventory event in the time that it would be relevant to a customer (i.e. in real-time or near real-time) would be extremely difficult, if not impossible, to perform manually using known methods and systems. Further, if a search navigation graph was not updated quickly, such as when a product had sold out, computer resources of other customer devices 150 may be wasted when they try to view, and possibly purchase, the sold-out product. As such, the present system helps to save computer resources by allowing for real-time implementation of the search navigation graph and limiting customer's searching to available inventory.

The update of the search navigation bar 370 may be performed in a number of different ways. Continuing with the above example, if the online store sells its last red clothing item and the red node is pruned during regeneration of the search navigation graph 368, the corresponding red icon on the search navigation bar 370 may simply disappear from the search navigation bar 370 as the search navigation bar 370 is displayed. Alternatively, the red icon may continue to be displayed in the search navigation bar 370, but it may become grayed-out and non-selectable as it is displayed.

In that manner, method 800 helps to minimize the number of inputs the customer must enter in order to search the available inventory and find the product he or she is looking for. Processing power may be saved since the processor has fewer inputs to process before the desired outcome is achieved. This may be particularly beneficial in the case where the customer device 150 has limited resources (e.g., is a handheld mobile device, which typically has fewer computer resources compared to desktop devices).

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A search navigation system for an online store, the search navigation system comprising:
a processing unit configured to execute instructions to cause the system to:
obtain attribute tags associated with available inventory associated with the online store;
detect a buyer event associated with the online store;
in response to the buyer event, generate a search navigation graph for the online store based on a search navigation template graph, the search navigation graph comprising a hierarchical graph wherein each node in the search navigation graph represents a respective attribute tag, and wherein the search navigation graph includes only nodes of the search navigation template graph representing attribute tags associated with the available inventory associated with the online store; and
cause a search navigation bar in a user interface to be displayed with selectable icons, the selectable icons each being a representation of a respective attribute tag represented by a respective node of the search navigation graph.

2. The system of claim 1, wherein the processing unit is further configured to generate the search navigation graph by:
pruning the search navigation template graph by removing a subgraph from the search navigation template graph, wherein the removed subgraph contains nodes representing attribute tags that are not associated with the available inventory associated with the online store.

3. The system of claim 2, wherein the processing unit is further configured to generate the search navigation graph by:
shrinking the search navigation template graph by identifying a hierarchical level in the search navigation template graph that contains only a single node and removing the identified hierarchical level from the search navigation template graph.

4. The system of claim 3, wherein the processing unit is further configured to generate the search navigation graph by:
promoting a node of the search navigation template graph by identifying the node as representing an attribute tag that is common to child nodes of two or more parent nodes at a common hierarchical level, and moving the identified common node to the common hierarchical level of the parent nodes.

5. The system of claim 4, wherein the processing unit is further configured to generate the search navigation graph by performing the pruning, the shrinking, and the promoting iteratively until a convergence condition is satisfied.

6. The system of claim 4, wherein the processing unit is further configured to, in response to a change in the available inventory associated with the online store that changes the attribute tags associated with the available inventory, regenerate the search navigation graph to correspond to the inventory change, and cause the search navigation bar on the user interface to be updated to correspond with the regenerated search navigation graph.

7. The system of claim 6, wherein the processing unit is further configured to regenerate the search navigation graph in response to the change in the available inventory associated with the online store by repeating the pruning, the shrinking, and the promoting.

8. The system of claim 6, further comprising a memory in communication with the processing unit, the memory being configured to store a copy of the search navigation graph in association with the online store after the search navigation graph is generated.

9. The system of claim 1, wherein the processing unit is further configured to apply a filter to the available inventory, regenerate the search navigation graph to correspond to the filtered inventory, and cause the search navigation bar on the user interface to be updated to correspond with the regenerated search navigation graph.

10. The system of claim 9, wherein the filter is associated with a particular page of the online store and the processing unit is further configured to apply the filter to the available inventory associated with the online store when a customer navigates to the particular page of the online store.

11. The system of claim 1, wherein the attribute tags are visual attribute tags associated with visual attributes of the available inventory associated with the online store.

12. A search navigation method for an online store, the method comprising:
obtaining attribute tags associated with available inventory associated with the online store;
detecting a buyer event associated with the online store;
in response to the buyer event, generating a search navigation graph for the online store based on a search navigation template graph and the attribute tags, the search navigation graph comprising a hierarchical graph wherein each node in the search navigation graph represents a respective attribute tag, and wherein the search navigation graph includes only nodes of the search navigation template graph representing attribute tags associated with the available inventory associated with the online store; and
causing a search navigation bar in a user interface to be displayed with selectable icons, the selectable icons each being a representation of a respective attribute tag represented by a respective node of the search navigation graph.

13. The method of claim 12, wherein generating the search navigation graph comprises:
pruning the search navigation template graph by removing a subgraph from the search navigation template graph, wherein the removed subgraph contains nodes representing attribute tags that are not associated with the available inventory associated with the online store.

14. The method of claim 13, wherein generating the search navigation graph further comprises:
shrinking the search navigation template graph by identifying a hierarchical level in the search navigation template graph that contains only a single node and removing the identified hierarchical level from the search navigation template graph.

15. The method of claim 14, wherein generating the search navigation graph further comprises:
promoting a node of the search navigation template graph by identifying the node as representing an attribute tag that is common to child nodes of two or more parent nodes at a common hierarchical level, and moving the identified common node to the common hierarchical level of the parent nodes.

16. The method of claim 15, wherein generating the search navigation graph comprises performing the pruning, the shrinking, and the promoting iteratively until a convergence condition is satisfied.

17. The method of claim 15, wherein, in response to a change in the available inventory associated with the online store that changes the attribute tags associated with the available inventory, regenerating the search navigation graph to correspond to the inventory change, and causing the search navigation bar on the user interface to be updated to correspond with the regenerated search navigation graph.

18. The method of claim 12, further comprising storing a copy of the search navigation graph in association with the online store after the search navigation graph is generated.

19. The method of claim 17, wherein the change in the available inventory associated with the online store is a depletion of available inventory associated with a particular attribute tag, and regenerating the search navigation graph to remove the node representing the particular attribute tag causes the selectable icon corresponding to the particular attribute tag to become grayed-out in the search navigation bar.

20. The method of claim 12, further comprising applying a filter to the available inventory, regenerating the search navigation graph to correspond to the filtered inventory, and causing the search navigation bar on the user interface to be updated to correspond with the regenerated search navigation graph.

21. A computer-readable medium storing instructions that, when executed by a processor of a system, causes the system to:
obtain attribute tags associated with available inventory associated with the online store;
detect a buyer event associated with the online store;
in response to the buyer event, generate a search navigation graph for the online store based on a search navigation template graph and the attribute tags, the search navigation graph comprising a hierarchical graph wherein each node in the search navigation graph represents a respective attribute tag, and wherein the search navigation graph includes only nodes of the search navigation template graph representing attribute tags associated with the available inventory associated with the online store; and
cause a search navigation bar in a user interface to be displayed with selectable icons, the selectable icons each being a representation of a respective attribute tag represented by a respective node of the search navigation graph.
